(19) United States
(12) Patent Application Publication
(10) Pub. No.: US 2011/0109495 A1
(43) Pub. Date: May 12, 2011

(54) RADAR APPARATUS

(75) Inventors: Shinichi Takeya, Kanagawa (JP); Kazuaki Kawabata, Kanagawa (JP); Kazuki Oosuga, Kanagawa (JP); Takuji Yoshida, Kanagawa (JP); Tomohiro Yoshida, Kanagawa (JP); Masato Niwa, Kanagawa (JP); Hideto Goto, Kanagawa (JP)

(73) Assignee: KABUSHIKI KAISHA TOSHIBA, Tokyo (JP)

(21) Appl. No.: 13/002,065

(22) PCT Filed: Mar. 19, 2010
(86) PCT No.: PCT/JP2010/054837

§ 371 Date: Dec. 30, 2010

(30) Foreign Application Priority Data
Jun. 8, 2009 (JP) 2009-137311

(51) Int. Cl. G01S 13/44

(52) U.S. Cl. 342/107; 342/154

(57) ABSTRACT

The present invention includes: an antenna 10 including an element 11a for use in both transmission and reception that is divided into a first transmission/reception element and a second transmission/reception element, and an element 12a for reception only that is divided into a first only-reception element and a second only-reception element; a beam shaping unit 34 that divides an angle region to be observed into a plurality of regions, and forms transmission beams by using the respective elements of the antenna so that the divided angle regions are covered by the transmission beams, and in reception, sets aimed beam direction of each element of the antenna to be the same as that of the first transmission/reception element, and that of the second transmission/reception element, forms phase monopulse beam of Σ and Δ by using the first transmission/reception element and the first only-reception element, and the second transmission/reception element and the second only-reception element to cover each of the plurality of angle regions, and forms a beam with a narrow beam width by the first transmission/reception element, the second transmission/reception element, the first only-reception element, and the second only-reception element; and an angle measuring unit 37 that performs monopulse angle measurement based on the beam formed in the beam shaping unit.

### FIELD OF THE INVENTION

The present invention relates to a radar apparatus that observes a direction (angle) of a vehicle and the like.

### BACKGROUND ART

When vehicles traveling on a road are observed by a radar apparatus, a small-sized antenna is used. FIG. 1 is a system diagram showing a configuration of a conventional radar apparatus. FIG. 2 is a flowchart showing operations of this radar apparatus. This radar apparatus includes an antenna 10, a transmitter/receiver 20, and a signal processor 30.

A signal swept by a transmitter 21 inside the transmitter/receiver 20 is transmitted from an antenna transmission element 11. On the other hand, signals received by multiple antenna receive elements 12 each undergo frequency conversion by multiple mixers 22, and then are sent to the signal processor 30. The signal processor 30 receives a signal from the transmitter/receiver 20 (step S201), and the signal is converted by an AD converter 31 into a digital signal, which is sent to an FFT unit 32 as an element signal.

The FFT unit 32 converts a signal sent from the AD converter 31 into an element signal on the frequency axis by the Fast Fourier Transform, and forwards the element signal to a DBF (Digital Beam Forming) unit 34. The DBF unit 33 forms a Σ beam and a Δ beam by using the element signal on the frequency axis sent from the FFT unit 32. The Σ beam formed in the DBF unit 33 is sent to a detection unit 35, and the Δ beam formed in the DBF unit 33 is sent to an angle measuring unit 37. The detection unit 35 detects a target based on the Σ beam sent from the DBF unit 33, and forwards the detection result to a range and velocity measuring unit 36.

Subsequently, a range and a velocity are calculated (step S202). That is, the range and velocity measuring unit 36 measures the target's range and the target's velocity based on the detection result from the detection unit 35, and sends the range and velocity to the outside and also sends the Σ beam to the angle measuring unit 37.

Subsequently, an angle is calculated (step S203). That is, the angle measuring unit 37 measures an angle by the monopulse system as shown in FIG. 3 using the Σ beam sent from the range and velocity measuring unit 36 and the Δ beam sent from the DBF unit 33. The monopulse system is described in Non-patent Document 1. The angle obtained by the measurement of angle in the angle measuring unit 37 is sent to the outside.

Subsequently, correlation tracking is performed (step S204). That is, an unillustrated correlation tracking unit provided outside calculates the position and velocity of the target based on the range, velocity, and angle that are sent from the signal processor 30. Subsequently, it is checked whether the cycles are completed or not (step S205). If it determined that the cycles are not completed in step S205, processing for setting the next cycle as a target to be processed is performed (step S206). Subsequently, the process returns to step S201 and the above-described processing is repeated. On the other hand, if it is determined that the cycles are completed in step S205, the tracking processing of the radar apparatus is terminated.

Here, a case where an error exists between antenna elements is considered. This error is an amplitude or phase error occurred due to a temperature and temporal change and the like of a line length and a mixer as shown in FIG. 4. In this case, as shown in FIG. 5, e.g., a gain reduction, a deviation in the aimed direction occurs, and thus detection or angle measurement capability is reduced due to the influence.

### PRIOR ART DOCUMENT

### Non-Patent Document

Non-patent Document 1: Takashi Yoshida (editorial supervision), “Radar Technology, revised version”, the Institute of Electronics, Information and Communication Engineers, pp. 260 to 264 (1996)

### SUMMARY OF THE INVENTION

### Problems to be Solved by the Invention

As described above, the conventional radar apparatus has the following problems. That is, when vehicles traveling on a road are observed by the radar, a small-sized antenna with a small number of elements is used by the radar, and thus, in general, a problem occurs in that sidelobes are increased to cause erroneous detection and deterioration of angle measurement accuracy. Also, another problem occurs in that an amplitude and phase between antenna elements are changed due to a temperature and temporal change and the like, and thus a gain and angle measurement capability after beam synthesizing are reduced.

An object of the present invention is to provide a radar apparatus capable of observing a target with high precision by preventing erroneous detection and deterioration of angle measurement accuracy due to a sidelobe as well as reduction in detection capability or angle measurement capability due to a temperature and temporal change and the like.

### Means for Solving the Problems

To solve the above problems, a first invention includes: an antenna including an element for use in both transmission and reception that is divided into a first transmission/reception element and a second transmission/reception element, and an element for reception only that is divided into a first only-reception element and a second only-reception element; a beam shaping unit that divides an angle region to be observed into a plurality of regions, and forms transmission beams by using the respective elements of the antenna so that the divided angle regions are covered by the transmission beams, and in reception, sets aimed beam direction of each element of the antenna to be the same as that of the first transmission/reception element, and that of the second transmission/reception element, forms phase monopulse beam of Σ and Δ by using the first transmission/reception element and the first only-reception element, and the second transmission/reception element and the second only-reception element to cover each of the plurality of angle regions, and forms a beam with a narrow beam width by the first transmission/reception element, the second transmission/reception element, the first only-reception element, and the second only-reception element; and an angle measuring unit that performs monopulse angle measurement based on the beam formed in the beam shaping unit.

A second invention includes: an antenna that has a plurality of elements; a beam shaping unit that forms a beam shaped by multiplying absolute values of a plurality of received beams formed based on a plurality of signals from the antenna by a predetermined coefficient, and by adding resultant values of the multiplication; and an angle measuring unit that performs monopulse angle measurement for a beam exceeding a predetermined threshold out of beams formed in the beam shaping unit.

A third invention includes: an antenna that has a plurality of elements; a first beam shaping unit that forms a first beam shaped by multiplying absolute values of a plurality of received beams formed based on a plurality of signals from the antenna by a predetermined coefficient, and by adding resultant values of the multiplication; a second beam shaping unit that forms a second beam shaped by multiplying absolute values of a plurality of received beams formed based on a plurality of signals from the antenna by a predetermined coefficient, and by adding resultant values of the multiplication; and an angle measuring unit that performs monopulse angle measurement for a beam exceeding a predetermined threshold out of the first beams formed in the first beam shaping unit by using the first beam and the second beam formed in the second beam shaping unit.

A fourth invention includes: an antenna that has a plurality of elements; an FFT unit that samples a signal from an antenna that transmits an FMCW modulated frequency sweep signal or receives an interference wave from an oncoming vehicle, and performs Fast Fourier Transform on the signal; a correction circuit that performs any one of a correction in which, when an output of the FFT unit exceeds a predetermined threshold, least square fitting is performed for phases for respective elements with a first degree equation and phase planes are aligned so as to match to a slope of a straight line; and a correction in which, when an output of the FFT unit exceeds the predetermined threshold, monopulse angle measurement is performed and phase planes are aligned so as to match to phase slope according to a measured angle value obtained by the monopulse angle measurement; and an angle measuring unit that performs monopulse angle measurement after correction by the correction circuit.

A fifth invention includes: an antenna that has a plurality of elements; a detection unit that transmits an FMCW modulated frequency sweep signal, and detects a beam with the maximum value or a beam with the maximum value different from a second largest output level for a predetermined level or more, or two beams apart from each other with one or more beams therebetween that have a predetermined level difference or loss, out of outputs of a plurality of beams of the same frequency bank on a beat frequency axis where the transmitted signal is demodulated; a range and velocity measuring unit that performs range and velocity measurement for a plurality of frequency banks by using a beam detected in the detection unit; and an angle measuring unit that performs angle measurement for a plurality of frequency banks by using a beam detected in the detection unit.

### Effects of the Invention

According to the present invention, a radar apparatus with high angle measurement accuracy can be achieved even with a small-sized antenna that is, for example, mounted on a vehicle by reducing sidelobes and by correcting an error to reduce erroneous detection even if a temperature or temporal change occurs.

### BRIEF DESCRIPTION OF DRAWINGS

FIG. 1 is a system diagram showing a configuration of a conventional radar apparatus.

FIG. 2 is a flowchart showing operations of the conventional radar apparatus.

FIG. 3 is a graph for explaining angle measurement performed by a monopulse system in the conventional radar apparatus.

FIG. 4 is a diagram for explaining an error between antenna elements occurred in the conventional radar apparatus.

FIG. 5 is a graph for explaining the influence of gain reduction and aimed direction due to an error between antenna elements occurred in the conventional radar apparatus.

FIG. 6 is a system diagram showing a configuration of a radar apparatus according to Embodiment 1 of the present invention.

FIG. 7 is a flowchart showing operations of the radar apparatus according to Embodiment 1 of the present invention.

FIG. 8 is a system diagram showing a configuration of a radar apparatus according to Embodiment 2 of the present invention.

FIG. 9 is a flowchart showing operations of the radar apparatus according to Embodiment 2 of the present invention.

FIG. 10 is a graph for explaining operations of the radar apparatuses according to Embodiment 1 and Embodiment 2 of the present invention.

FIG. 11 is a graph for explaining operations of the radar apparatus according to Embodiment 1 of the present invention.

FIG. 12 is a graph for explaining operations of the radar apparatus according to Embodiment 2 of the present invention.

FIG. 13 is a graph for explaining operations of the radar apparatus according to Embodiment 2 of the present invention.

FIG. 14 is a diagram for explaining operations of a radar apparatus according to Embodiment 3 of the present invention.

FIG. 15 is a flowchart showing operations of the radar apparatus according to Embodiment 3 of the present invention.

FIG. 16 is a system diagram showing a configuration of a radar apparatus according to Embodiment 4 of the present invention.

FIG. 17 is a flowchart showing operations of the radar apparatus according to Embodiment 4 of the present invention.

FIG. 18 is a graph for explaining operations of the radar apparatuses according to Embodiment 3 and Embodiment 4 of the present invention.

FIG. 19 is a graph for explaining operations of the radar apparatuses according to Embodiment 3 and Embodiment 4 of the present invention.

FIG. 20 is a graph for explaining operations of the radar apparatuses according to Embodiment 3 and Embodiment 4 of the present invention.

FIG. 21 is a graph for explaining operations of the radar apparatuses according to Embodiment 3 and Embodiment 4 of the present invention.

FIG. 22 is a graph for explaining operations of the radar apparatuses according to Embodiment 3 and Embodiment 4 of the present invention.

FIG. 23 is a graph for explaining operations of the radar apparatuses according to Embodiment 3 and Embodiment 4 of the present invention.

FIG. 24 is a flowchart showing operations of a radar apparatus according to Embodiment 5 of the present invention.

FIG. 25 is a flowchart showing operations of the radar apparatus according to a modification of Embodiment 5 of the present invention.

FIG. 26 is a graph for explaining operations of the radar apparatus according to Embodiment 5 of the present invention.

FIG. 27 is a flowchart showing operations of a radar apparatus according to Embodiment 6 of the present invention.

FIG. 28 is a graph for explaining operations of the radar apparatus according to Embodiment 6 of the present invention.

FIG. 29 is a system diagram showing a configuration of a radar apparatus according to Embodiment 7 of the present invention.

FIG. 30 is a graph for explaining operations of the radar apparatus according to Embodiment 7 of the present invention.

FIG. 31 is a graph for explaining operations of the radar apparatus according to Embodiment 7 of the present invention.

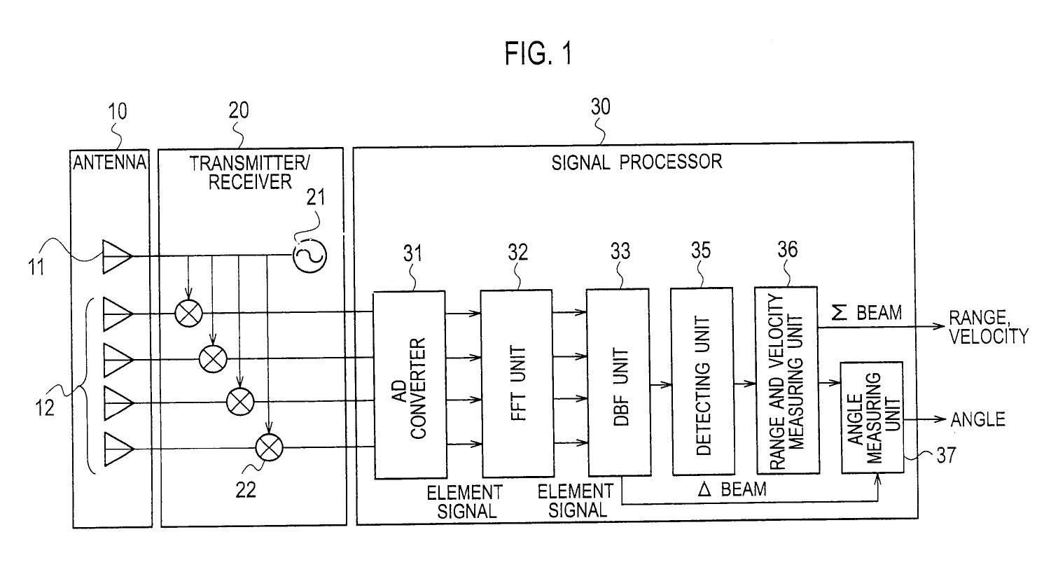

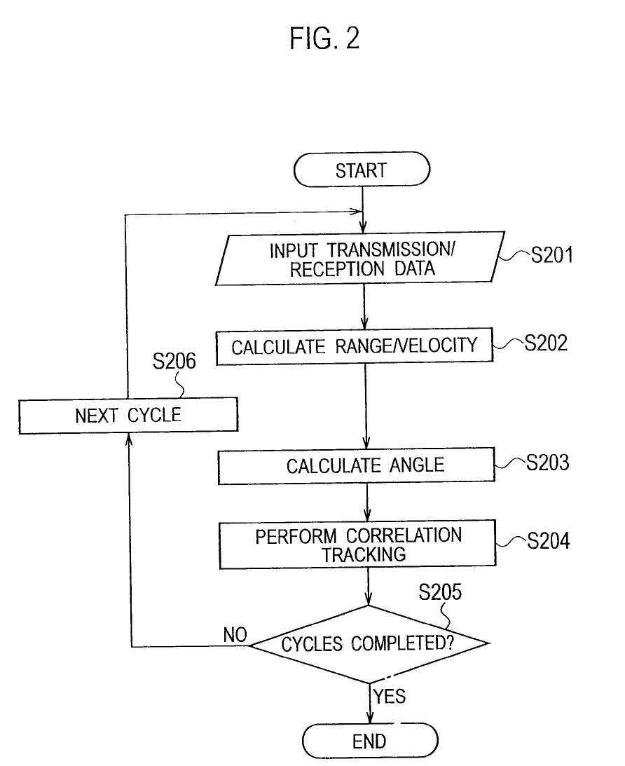

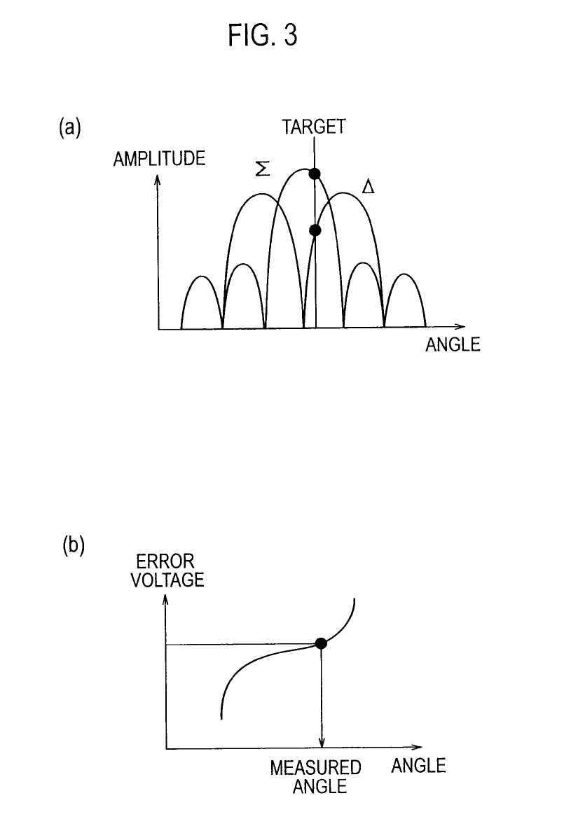

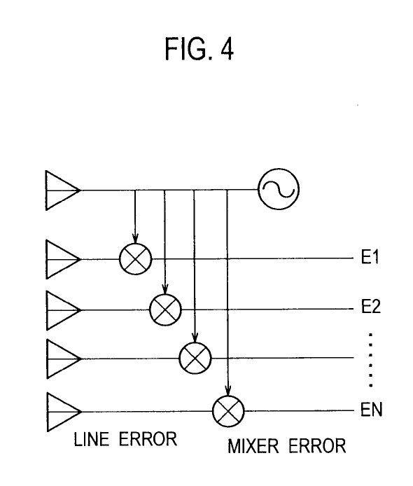

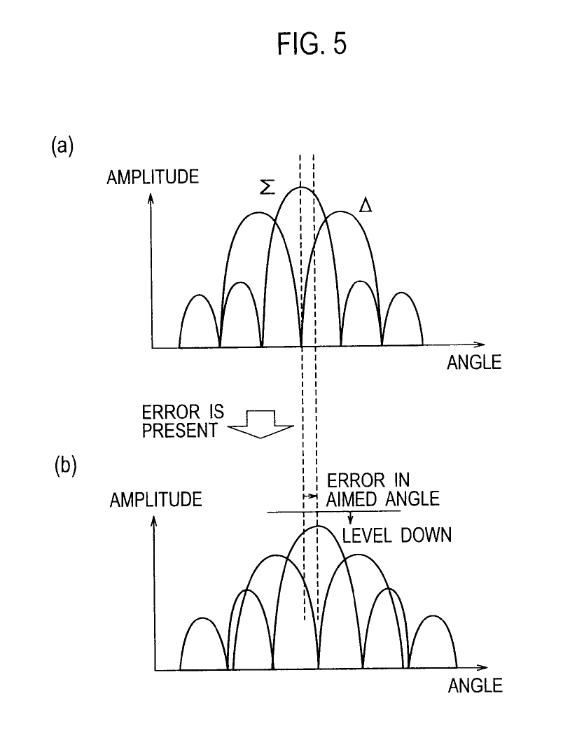

### BEST MODES FOR CARRYING OUT THE INVENTION

In the following, a radar apparatus of the embodiments of the present invention are described in detail with reference to the drawings.

### Embodiment 1

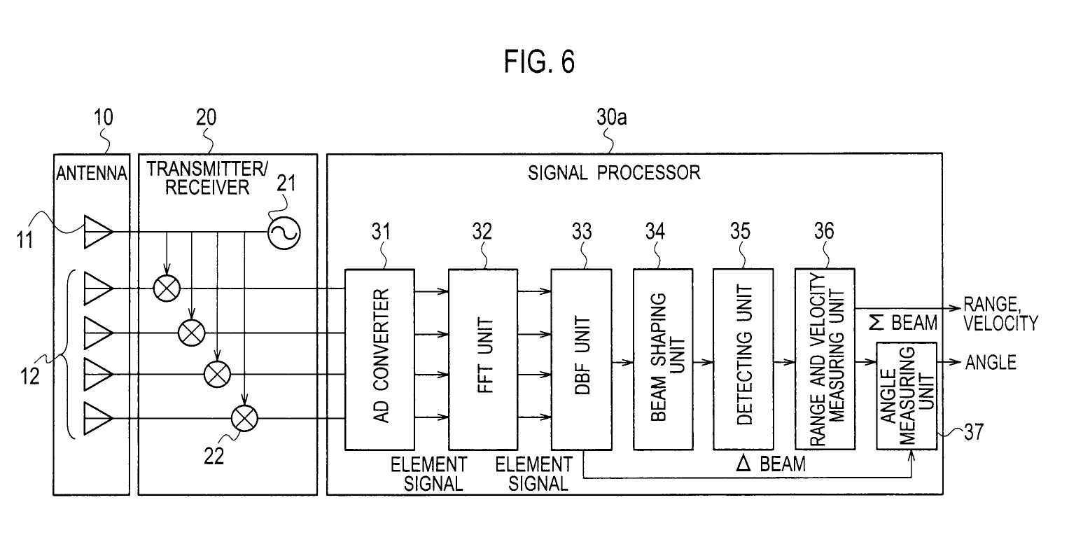

FIG. 6 is a system diagram showing a configuration of a radar apparatus according to Embodiment 1 of the present invention. This radar apparatus includes an antenna 10, a transmitter/receiver 20, and a signal processor 30a.

The antenna 10 is configured with an antenna transmitting element 11 and multiple antenna receiving elements 12. The antenna transmitting element 11 converts a transmission signal transmitted from the transmitter/receiver 20 as an electrical signal into a radio wave to send it to the outside. Multiple antenna receiving elements 12 receive radio waves from the outside to convert them into electrical signals, and send the signals as reception signals to the transmitter/receiver 20.

The transmitter/receiver 20 includes a transmitter 21 and multiple mixers 22. The multiple mixers 22 are provided for respective multiple antenna receiving elements 12. Transmitter 21 generates a transmission signal and sends the signal to the antenna transmitting element 11 and the multiple mixers 22. The multiple mixers 22 performs frequency conversion on the reception signals received from multiple respective antenna receiving elements 12 according to the signal from the transmitter 21, and sends the converted signals to the signal processor 30.

The signal processor 30a includes an AD converter 31, an FFT unit 32, a DBF unit 33, a beam shaping unit 34, a detection unit 35, a range and velocity measuring unit 36, and an angle measuring unit 37.

The AD converter 31 converts an analog signal sent from the transmitter/receiver 20 into a digital signal, and forwards the digital signal to the FFT unit 32 as an element signal. The FFT unit 32 converts an element signal sent from the AD converter 31 into an element signal on the frequency axis by the Fast Fourier Transform, and forwards the converted element signal to the DBF unit 33.

The DBF unit 33 forms a Σ beam and a Δ beam by using the signal on the frequency axis sent from the FFT unit 32. The Σ beam formed in the DBF unit 33 is sent to the beam shaping unit 34, and the Δ beam formed in the DBF unit 33 is sent to the angle measuring unit 37.

The beam shaping unit 34 synthesizes the Σ beams sent from the DBF unit 33, and forwards the resultant beam to the detection unit 35. The detection unit 35 detects a target based on the synthesized Σ beam sent from the beam shaping unit 34, and forwards the detection result to the range and velocity measuring unit 36.

The range and velocity measuring unit 36 performs range and velocity measurement based on the detection result sent from the detection unit 35. The range and velocity obtained by the range and velocity measurement in the range and velocity measuring unit 36 are outputted to the outside.

The angle measuring unit 37 performs angle measurement based on the Σ beam sent from the DBF unit 33 via the beam shaping unit 34, the detection unit 35, and the range and velocity measuring unit 36 and the Δ beam sent from the DBF unit 33. The angle obtained by angle measurement in the angle measuring units 37 is outputted to the outside.

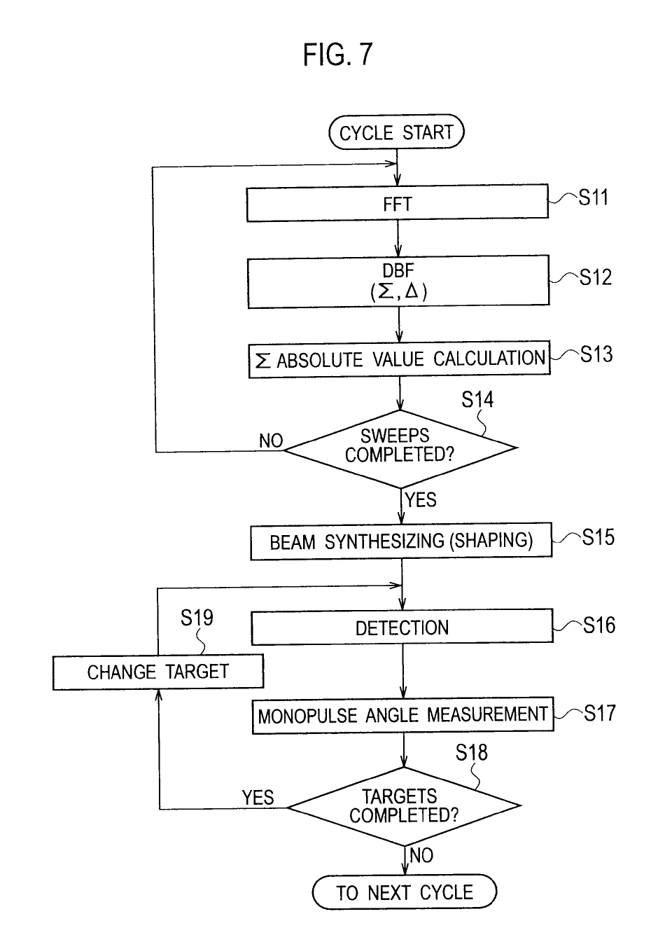

Next, operations of the radar apparatus according to Embodiment 1 of the present invention configured in this manner are described with reference to the flowchart shown in FIG. 7.

When a cycle is started, the Fast Fourier Transform (FFT) is first performed (step S11). That is, (FM modulated) sweep signal whose frequency is continuously changed, is transmitted from the antenna transmitting element 11, and then the transmitted signal is received by multiple antenna receiving elements 12. The received signal undergoes frequency conversion in the transmitter/receiver 20, and is then sent to the AD converter 31 of the signal processor 30.

The AD converter 31 converts an analog signal sent from the transmitter/receiver 20 into a digital signal, and sends the digital signal to the FFT unit 32 as an element signal. The FFT unit 32 performs the Fast Fourier Transform on the element signal sent from the AD converter 31. Thereby, an element signal on the frequency axis is obtained. The element signal on the frequency axis obtained by the FFT unit 32 is forwarded to the DBF unit 33.

Subsequently, DBF processing is performed (step S12). That is, the DBF unit 33 forms a Σ beam and a Δ beam by using the signal on the frequency axis sent from the FFT unit 32. The Σ beam formed in the DBF unit 33 is sent to the beam shaping unit 34, and the Δ beam formed in the DBF unit 33 is sent to the angle measuring unit 37.

Subsequently, Σ absolute value calculation is performed (step S13). That is, the beam forming units 34 calculates the absolute value of the Σ beam sent from the DBF unit 33. Subsequently, it is checked whether the sweeps are completed or not (step S14). That is, it is checked whether processing for all sweeps is completed or not. If the sweeps are not completed in step S14, the process returns to step S11, then the above-described processing is repeated for the next sweep signal.

On the other hand, if the sweeps are completed in step S14, beam synthesizing is performed (step S15). That is, the beam shaping unit 34 multiplies the absolute values of the Σ beams calculated in step S13 by a predetermined coefficient and adds the resultant values of the multiplication for beam forming (synthesizing), and sends the beam to the detection unit 35.

Subsequently, detection processing is performed (step S16). That is, the detection unit 35 detects a target based on the synthesized Σ beam sent from the beam shaping unit 34, then forwards the detection result to the range and velocity measuring unit 36. The range and velocity measuring unit 36 performs range and velocity measurement based on the detection result sent from the detection unit 35, and then outputs the range and velocity obtained by the range and velocity measurement to the outside.

Subsequently, monopulse angle measurement is performed (step S17). That is, the angle measuring unit 37 performs monopulse angle measurement (amplitude monopulse angle measurement, phase monopulse angle measurement, squint monopulse angle measurement, or the like) based on the Σ beam sent from the DBF unit 33 via the beam shaping unit 34, the detection unit 35, and the range and velocity measuring unit 36 and the Δ beam sent from the DBF unit 33, and then outputs the angle obtained by this angle measurement to the outside.

It is then checked whether the targets are completed or not (step S18). That is, it is checked whether processing for all the targets is completed. If the targets are not completed in step S18, the target is changed to the next target (step S19), and subsequently, the process returns to step S16, and then the above-described processing is repeated. On the other hand, if the targets are completed in step S18, the process is completed.

The radar apparatus mentioned above is further described. In a phased array including an antenna with N elements, M reception beams b1 to bM are formed. If the number of elements, N is large, sidelobes tend to be reduced; however, if the number of elements is small, control of amplitude weight becomes difficult, and thus sidelobes tend to be increased.

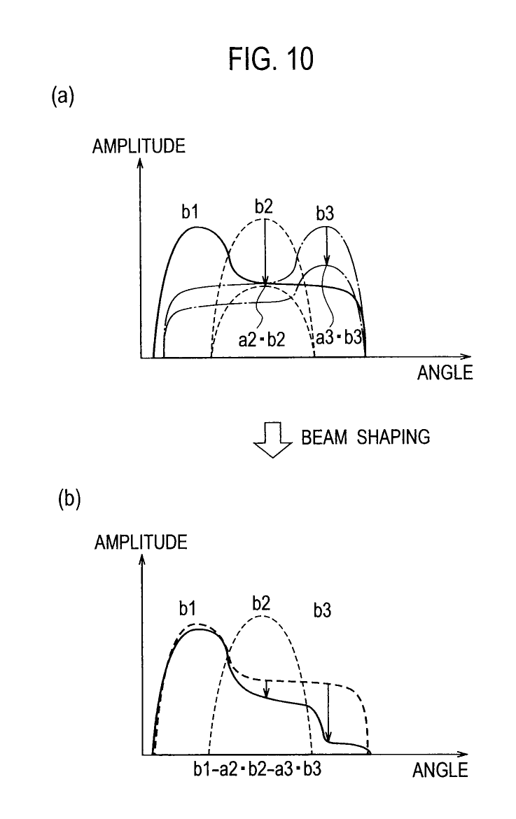

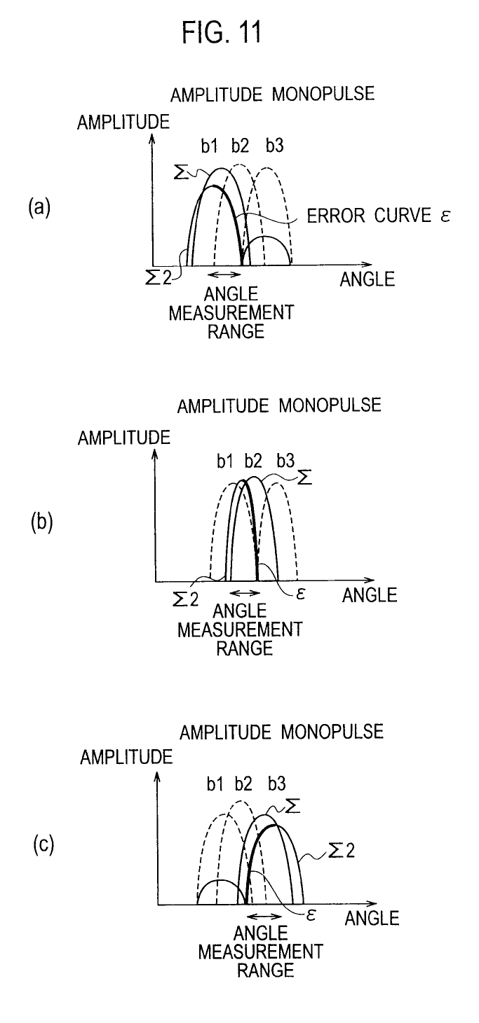

To address this, a method of reducing sidelobes by controlling amplitude phase weight also exists. However, this method is easily affected by a phase error, and thus the radar apparatus according to Embodiment 1 of the present invention forms ba1 to baM that are shaped by multiplying the absolute values of b1 to bM (M is an integer >1) by a predetermined coefficient and adding the resultant values of the multiplication as shown in FIG. 10. For the signal whose output of this shaped beam exceeds a threshold, the monopulse angle measurement (phase monopulse angle measurement, amplitude monopulse angle measurement, squint monopulse angle measurement, or the like) is performed. The beam for detection and the beam for angle measurement in the case of amplitude monopulse angle measurement are shown in FIG. 11. The beam for detection can be expressed by the following equation.

$$\begin{matrix}[ Equation 1 ] & \\ bm ( θ ) = {\sum }_{n = 1}^{N} Wm ( n ) \cdot E ( θ ) \cdot exp ( j \cdot \frac{2 π}{λ} \cdot d ( n - 1 - \frac{N - 1}{2} ) ) & ( 1 )\end{matrix}$$

where

bm(θ): M Σ beam outputs (m=1 to M),

E(θ): element pattern,

W(n): complex weight (n=1 to N),

n: element number (n=1 to N), and

λ: wave length.

Shaped beam (Σ beam which is a bam beam) is given by the following the equation:

$$\begin{matrix}[ Equation 2 ] & \\ bam ( θ ) = {\sum }_{m = 1}^{M} Km \cdot abs ( bm ( θ ) ) & ( 2 )\end{matrix}$$

where

bam(θ): shaped beam (m=1 to M),

abs[ ]: absolute value, and

Km: coefficient (m=1 to M).

The coefficient Km is determined so as to reduce the sidelobes of the bma.

Also, in the case of the phase monopulse angle measurement, for example, the Δ beam in the following equation can be used to measure an angle.

$$\begin{matrix} [ Equation 3 ] & \\ Δ ( θ ) = {\sum }_{n = 1}^{N / 2} Wm ( n ) \cdot E ( θ ) \cdot exp ( j \cdot \frac{2 π}{λ} \cdot d ( n - 1 - \frac{N - 1}{2} ) ) - {\sum }_{n = N / 2 + 1}^{N} Wm ( n ) \cdot E ( θ ) \cdot exp ( j \cdot \frac{2 π}{λ} \cdot d ( n - 1 - \frac{N - 1}{2} ) ) & ( 3 )\end{matrix}$$

The error voltage can be expressed by the following equation using the bam and Δ.

$$\begin{matrix}[ Equation 4 ] & \\ phase monopulse \text{:} ɛ = Re [ \frac{bam * {Δ}^{*}}{bam * {bam}^{*}} ] & ( 4 )\end{matrix}$$

where

*: complex conjugate.

The measured angle value, θ is calculated by using the ε and pre-stored corresponding table between the error voltage ε and θ (or approximated polynomial values).

In the case of amplitude monopulse, the beam for detection can be expressed by the following equation using the bam beam (Σ beam) and b2 beam (Σ2 beam) whose aimed direction is tilted.

$$\begin{matrix}[ Equation 5 ] & \\ b 2 ( θ ) = {\sum }_{n = 1}^{N} Wm 2 ( n ) \cdot E ( θ ) \cdot exp ( j \cdot \frac{2 π}{λ} \cdot d ( n - 1 - \frac{N - 1}{2} ) ) & ( 5 )\end{matrix}$$

where

Wm2(n): complex weight for tilting (n=1 to N).

The error voltage can be expressed by the following equation using the bam and b2.

$$\begin{matrix}[ Equation 6 ] & \\ amplitude monopulse \text{:} ɛ = \frac{\vert b \vert}{\vert bam \vert} & ( 6 )\end{matrix}$$

where

*: complex conjugate, and

b2: beam tilted with respect to the bam.

The measured angle value, θ can be calculated by using the ε and pre-stored corresponding table between the ε and θ (or approximated polynomial values).

As described above, according to the radar apparatus according to Embodiment 1 of the present invention, for a small-sized antenna with a small number of elements producing high sidelobes, by using M beams and multiplying the beams by a coefficient, the sidelobes can be reduced, thus erroneous detection can be reduced.

### Embodiment 2

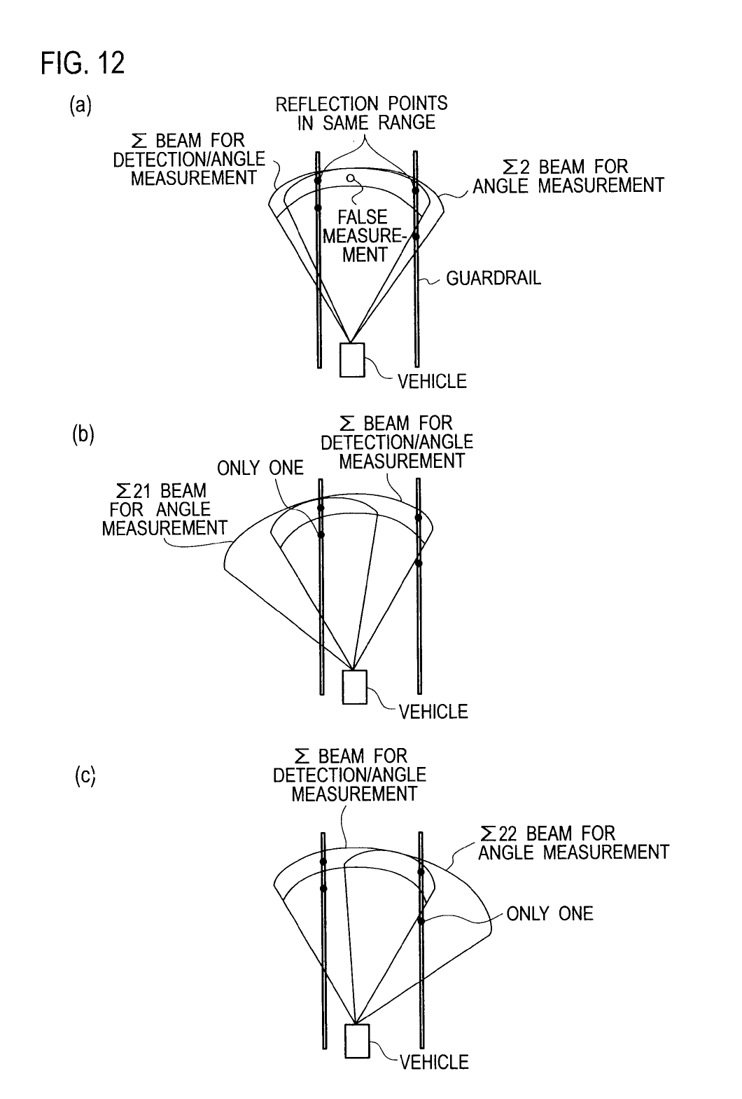

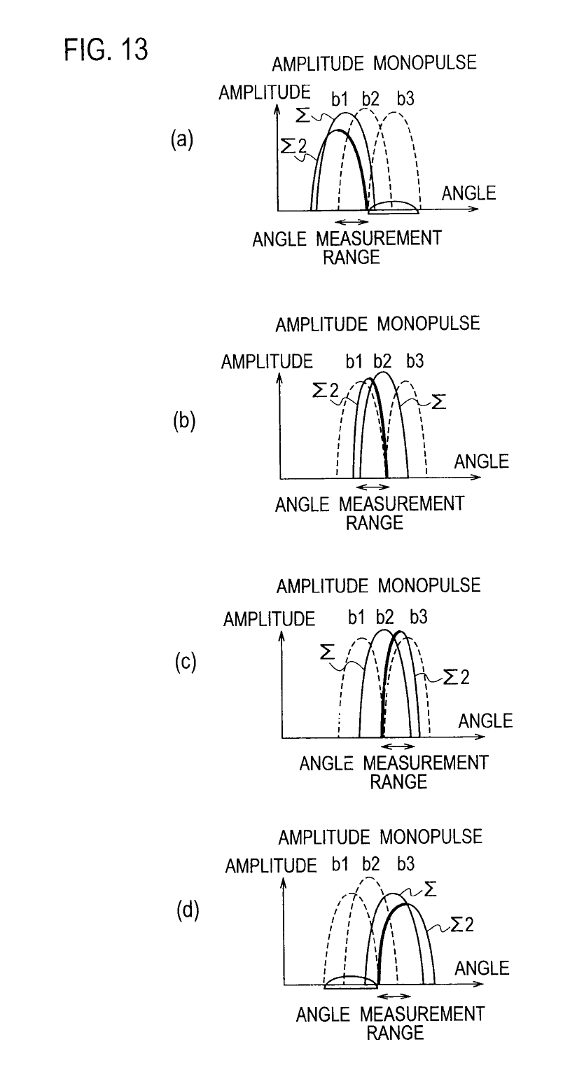

As shown in FIG. 12 (a), in the case where multiple reflection points of the same range exist within the Σ beam for detection, if the beam for angle measurement also includes multiple reflection points, error in the measured angle value may be increased. To address this, a radar apparatus according to Embodiment 2 of the present invention shapes the beam as well as changes the aimed direction so that multiple reflection points are not included in the beam for angle measurement as shown in FIGS. 12(b) and 12(c). FIG. 13 shows a measured angle region when the beams for angle measurement (the Σ beam, the Σ2 beam) are shaped.

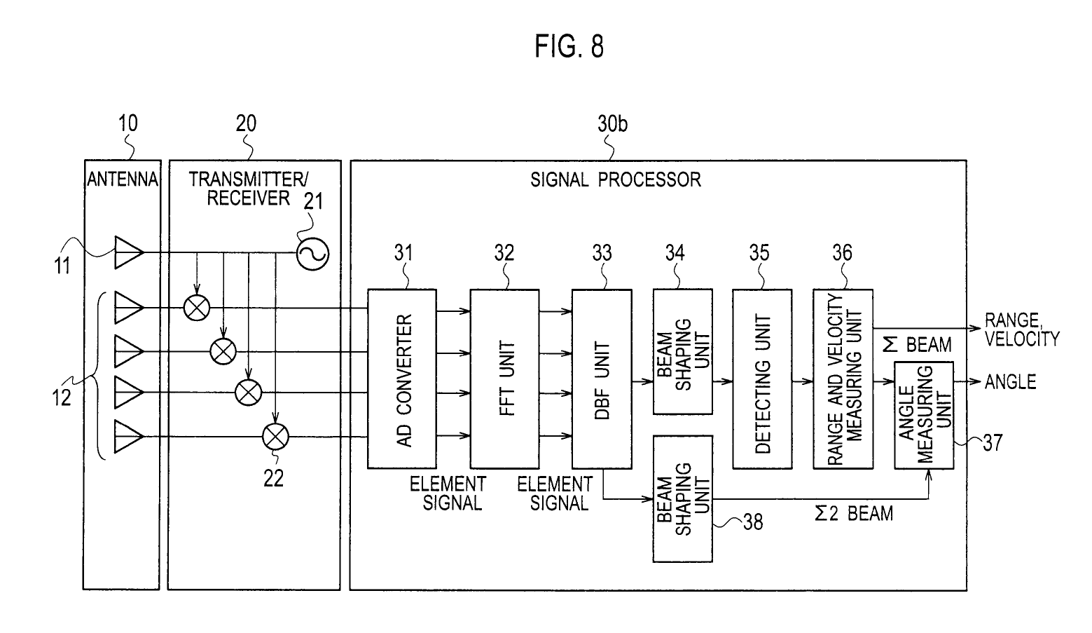

FIG. 8 is a system diagram showing a configuration of the radar apparatus according to Embodiment 2 of the present invention. This radar apparatus is configured by adding a beam shaping unit 38 to the signal processor 30a of the radar apparatus according to Embodiment 1. The beam shaping unit 38 forms a Σ2 beam based on a Σ beam sent from the DBF unit 33, and sends the Σ2 beam to an angle measuring unit 37. In the case of the radar apparatus according to Embodiment 2, the beam shaping unit 34 corresponds to a first beam shaping unit of the present invention, and the beam shaping unit 38 corresponds to a second beam shaping unit of the present invention. Also, the output of the beam shaping unit 34 corresponds to a first beam of the present invention, and the Σ2 beam, which is the output of the beam shaping unit 38, corresponds to a second beam of the present invention.

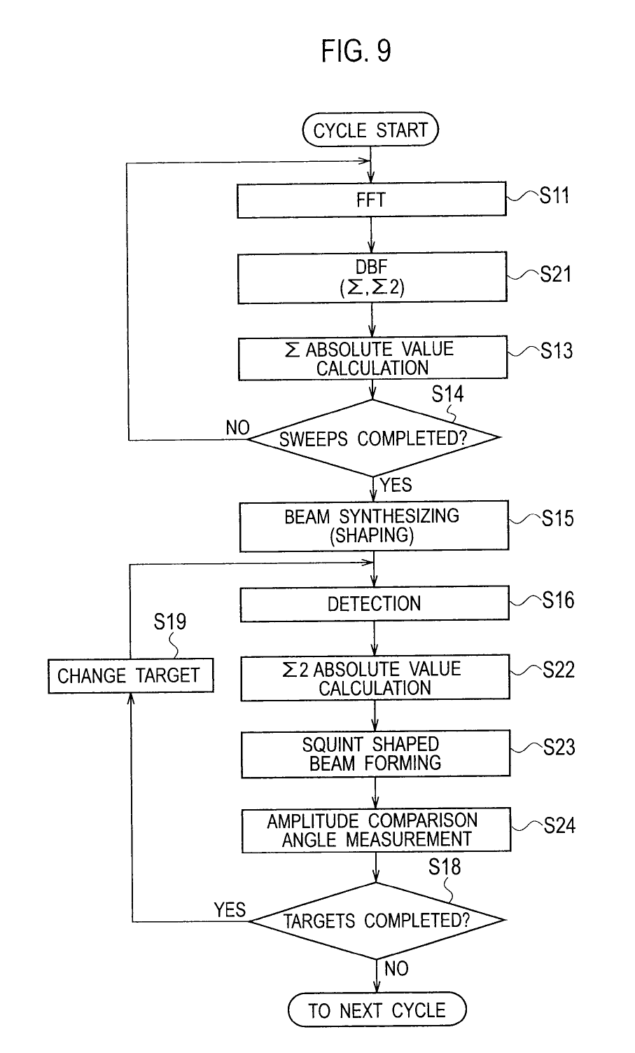

Next, operations of the radar apparatus according to Embodiment 2 of the present invention configured in this manner are described with reference to the flowchart shown in FIG. 9. The step in which identical or corresponding processing to the one in the radar apparatus according to Embodiment 1 is performed is labeled with the same reference numeral as used in the flowchart of FIG. 7, and its description is omitted.

When a cycle is started, the Fast Fourier Transform (FFT) is first performed (step S11). Subsequently, DBF processing is performed (step S21). The DBF unit 33 forms a Σ beam by using the signal on the frequency axis sent from the FFT unit 32. The Σ beam formed in the DBF unit 33 is sent to the beam shaping unit 34, and the beam shaping unit 38. Subsequently, the Σ absolute value calculation is performed (step S13). Subsequently, it is checked whether the sweeps are completed or not (step S14). If the sweeps are not completed in step S14, the process returns to step S11, and the above-described processing is repeated for the next sweep signal.

On the other hand, if the sweeps are completed in step S13, beam synthesizing is performed (step S15). Subsequently, detection processing is performed (step S16). Subsequently, the Σ2 absolute value calculation is performed (step S22). That is, the beam shaping unit 38 calculates the absolute values of the Σ beams sent from the DBF unit 33, and multiplies the absolute values by a predetermined coefficient and adds the resultant values of the multiplication to form a Σ2 beam, and sends the Σ2 beam to the angle measuring unit 37.

Subsequently, squint shaped beam forming is performed (step S23). Subsequently, amplitude comparison angle measurement is performed (step S24). That is, angle measuring unit 37 performs angle measurement processing for the signal whose output of a shaped beam exceeded a threshold.

Subsequently, it is checked whether the targets are completed or not (step S18). If the targets are not completed in step S18, the target is changed to the next target (step S19), and subsequently, the process returns to step S16, then the above-described processing is repeated. On the other hand, if the targets are completed in step S18, the process is completed.

In the following, the above-described processing is formulized. First, similarly to the case of the Embodiment 1, the beam for detection can be expressed by the Equations (1) and (2), and the beam for angle measurement is as follows:

$$\begin{matrix}[ Equation 7 ] & \\ bsm ( θ ) = {\sum }_{n = 1}^{N} Wsm ( n ) \cdot E ( θ ) \cdot exp ( j \cdot \frac{2 π}{λ} \cdot d ( n - 1 - \frac{N - 1}{2} ) ) & ( 7 )\end{matrix}$$

where

bsm(θ): M Σ beam outputs (m=1 to M),

E(θ): element pattern,

Wsm(n): complex weight (n=1 to N),

n: element number (n=1 to N), and

λ: wave length.

Shaped beam is given by the following the equation:

$$bsam ( θ ) = {\sum }_{m = 1}^{M} Ksm \cdot abs ( bsm ( θ ) ) \qquad ( 8 )$$

where

bsam(θ): shaped beam (m=1 to M),

abs[ ]: absolute value, and

Ksm: coefficient (m=1 to M).

The coefficient Ksm can be determined so as to reduce the sidelobes of the bsam. The error voltage can be expressed by the following equation using the bam and bsam.

$$\begin{matrix}[ Equation 9 ] & \\ amplitude monopulse \text{:} ɛ = [ \frac{bsam}{bam} ] & ( 9 )\end{matrix}$$

where

*: complex conjugate; and

bsam: a beam tilted with respect to bam

The measured angle value, θ is calculated by using the ε and pre-stored corresponding table between the error voltage ε and θ (or approximated polynomial values).

As shown in FIG. 13, the beam for angle measurement can measure the angle of the reflection points on both sides of the bam beam with reduced influence from the other one by using the beam scanned on the right and left for the center beam among the bams.

As described above, according to the radar apparatus according to Embodiment 2 of the present invention, for a small-sized antenna with a small number of elements producing high sidelobes, by using M beams and multiplying the beams by a coefficient, the sidelobes can be reduced, thus erroneous detection can be reduced, while also in the beam for angle measurement, sidelobes can be reduced by the beam shaping, and thus accuracy in angle measurement can be improved.

### Embodiment 3

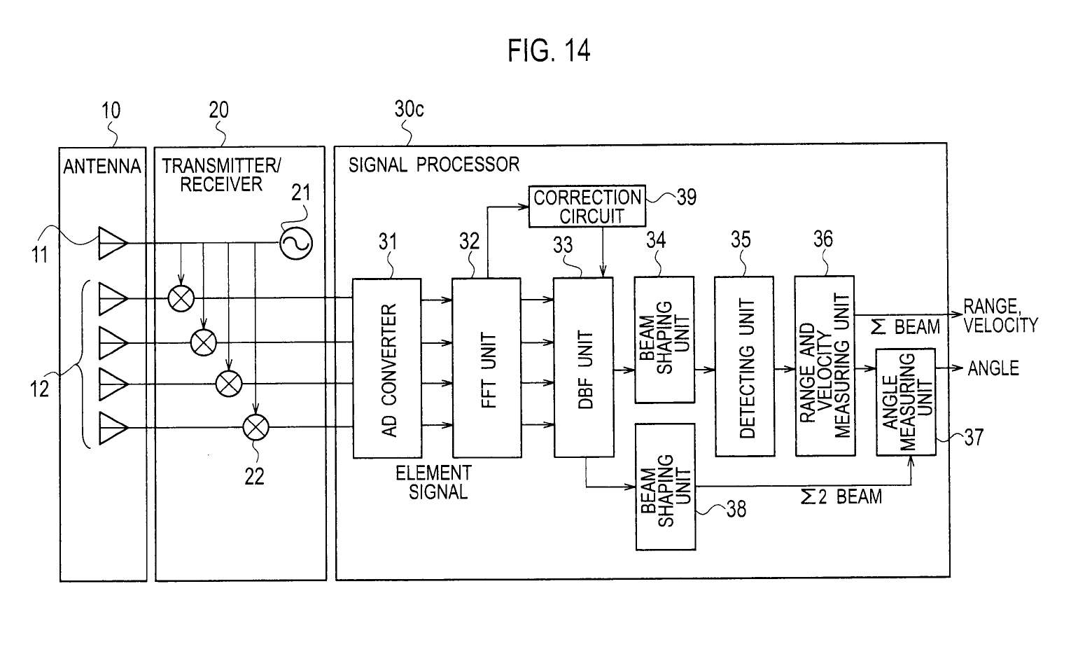

FIG. 14 is a system diagram showing a configuration of a radar apparatus according to Embodiment 3 of the present invention. This radar apparatus is configured by adding a correction circuit 39 to the signal processor 30b of the radar apparatus according to Embodiment 2. The correction circuit 39 calculates a correction coefficient based on a signal outputted from the FFT unit 32, and sends the coefficient to the DBF unit 33.

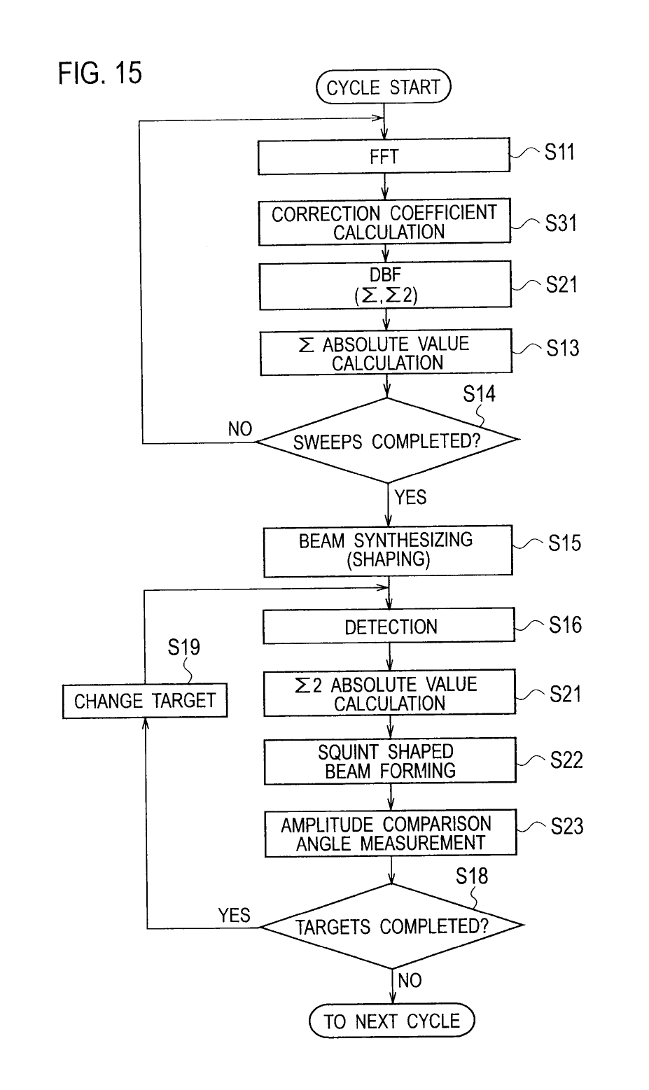

FIG. 15 is a flowchart showing operations of the radar apparatus according to Embodiment 3 of the present invention. This flowchart is configured by inserting correction coefficient calculation processing (step S31) between step S11 and step S12 in the flowchart showing the operations of the radar apparatus according to Embodiment 2 shown in FIG. 9. In the following, the step in which identical or corresponding processing to the one in the radar apparatus according to Embodiment 2 is performed is labeled with the same reference numeral as used in the flowchart of FIG. 9, and its description is omitted.

In the correction coefficient calculation processing in step S31, the correction circuit 39 calculates a correction coefficient based on a signal outputted from the FFT unit 32, and sends the correction coefficient to the DBF unit 33. The DBF unit 33 forms a Σ beam by using an element signal on the frequency axis sent from the FFT unit 32, and the correction coefficient sent from the correction circuit 39.

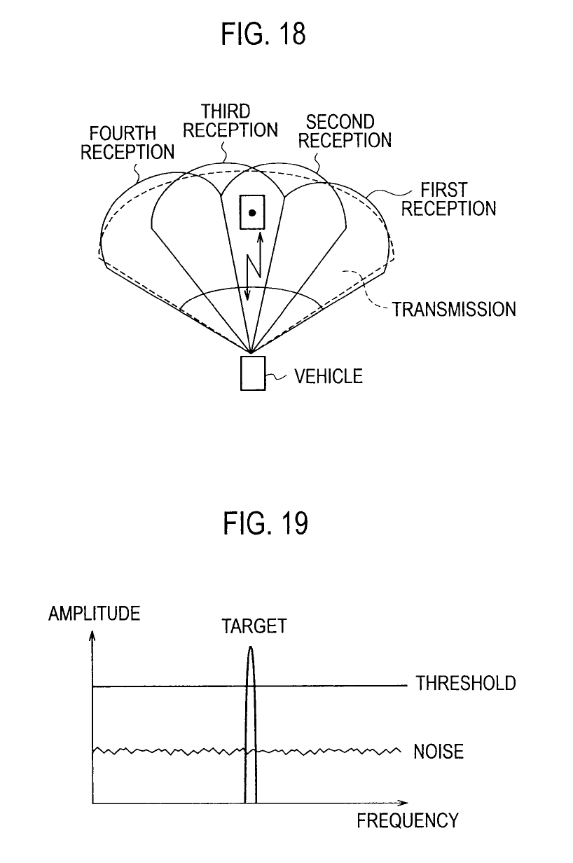

The step of correcting the amplitude and phase of an element signal is as shown below. In the case where as shown in FIG. 18, transmission/reception is performed in which a signal is transmitted to a region of observation in transmission, and a signal is received with the region of observation quadrisected in reception, or as shown in FIG. 21, a signal is only received with the region of observation quadrisected, a transmission/reception signal with a high S/N of the target is used.

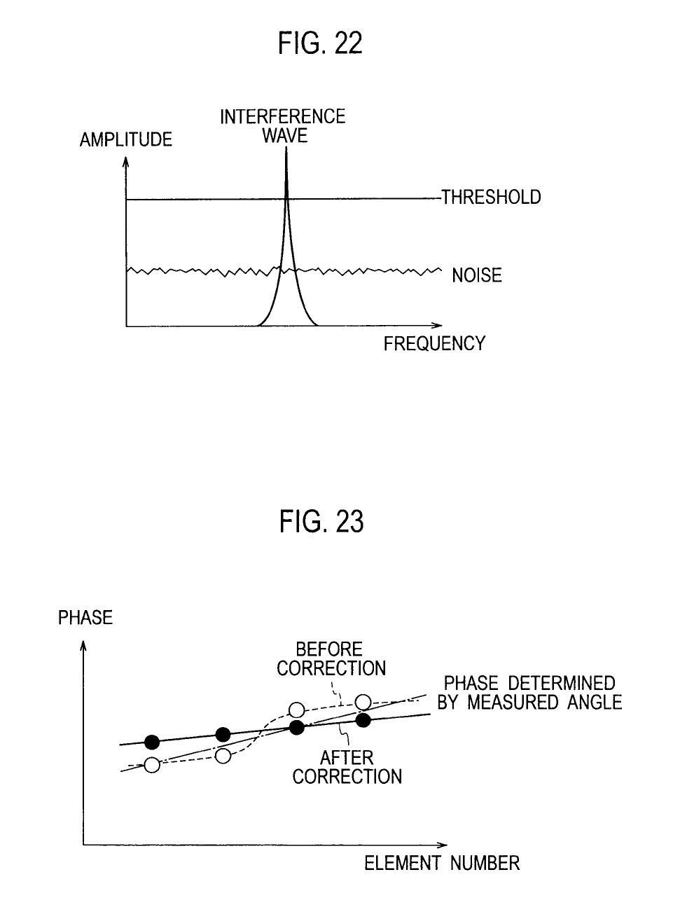

(1) Transmission/reception data E(n) of a target with a high S/N exceeding a predetermined threshold is extracted (see FIGS. 19 and 22).

(2) Phase (φe(n) of an antenna element is extracted.

[Equation 10]

φe(n)=ang[e(n)] (10)

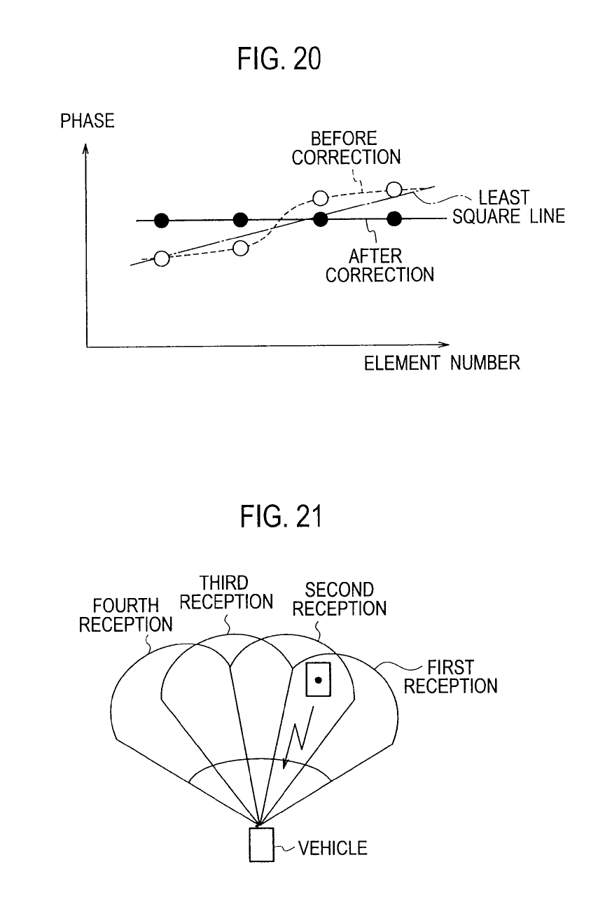

(3) The least square line is calculated from the element signal, and if slope coefficient a is a predetermined value or less, the target is determined to be at the front, and the following processing is performed (FIG. 20).

[Equation 11]

φe(n)=a·n+b (11)

where

a, b: slope coefficient, constant, and

n=1to N (N: the number of elements).

(4) Correction coefficient C(n) is common to the case of up-chirp signal and the case of down-chirp signal, and is given by the following:

$$\begin{matrix}[ Equation 12 ] & \\ C ( n ) = \frac{1}{e ( n )} = Ac ( n ) \cdot exp ( j \cdot φ c ( n ) ) & ( 12 )\end{matrix}$$

where

Φc: phase correction value, and

Ac: amplitude correction value.

When a beam is formed by using these correction coefficients, the element signal is multiplied by the correction coefficient C(n), then later, the beam is calculated by the following equation:

$$\begin{matrix} [ Equation 13 ] & \\ Σ ( θ ) = {\sum }_{n = 1}^{N} W ( n ) \cdot C ( n ) \cdot E ( θ ) \cdot exp ( j \cdot \frac{2 π}{λ} \cdot d ( n - 1 - \frac{N - 1}{2} ) ) & ( 13 ) \\ Δ ( θ ) = {\sum }_{n = 1}^{N / 2} W ( n ) \cdot C ( n ) \cdot E ( θ ) \cdot exp ( j \cdot \frac{2 π}{λ} \cdot d ( n - 1 - \frac{N - 1}{2} ) ) - {\sum }_{n = N / 2 + 1}^{N} W ( n ) \cdot C ( n ) \cdot E ( θ ) \cdot exp ( j \cdot \frac{2 π}{λ} \cdot d ( n - 1 - \frac{N - 1}{2} ) ) & \end{matrix}$$

where

Σ(θ): Σ beam output,

Δ(θ): Δ beam output,

E(θ): element pattern,

C(n): correction coefficient (n=1 to N),

W(n): weight (n=1 to N),

n: element number (n=1 to N), and

λ: wave length.

Monopulse angle measurement is performed using this beam. The monopulse angle measurement includes the phase monopulse and the amplitude monopulse, and the error voltage can be expressed by the following equation.

$$\begin{matrix}[ Equation 14 ] & \\ phase monopulse \text{:} ɛ = Re [ \frac{Σ * {Δ}^{*}}{Σ * {Σ}^{*}} ] & ( 14 ) \\ amplitude monopulse \text{:} ɛ = \frac{\vert Σ2 \vert}{\vert Σ \vert} & ( 15 )\end{matrix}$$

where

*: complex conjugate, and

Σ2: beam tilted with respect to the Σ.

The measured angle value, θ is calculated by using the ε and pre-stored corresponding table between the ε and θ (or approximated polynomial values).

Further, in Embodiment 1, the configuration may be such that the correction coefficient is calculated after determining that the target is in the vicinity of the front from that the slope of the line is below a predetermined value. According to this configuration, a large correction error can be avoided when the target is deviated from the front direction.

As described above, according to the radar apparatus according to Embodiment 3 of the present invention, the slope of the phase plane is observed by using a radar transmission/reception wave or a reception wave from an interference wave so that the amplitudes and phase planes of the antenna elements can be aligned so as to match the phase plane. Thereby, the formed beam distorted by an error can be formed into a sharp beam with less influence of error, and further beam shaping reduces sidelobes and erroneous detection so that accuracy in the angle measurement can be improved.

### Embodiment 4

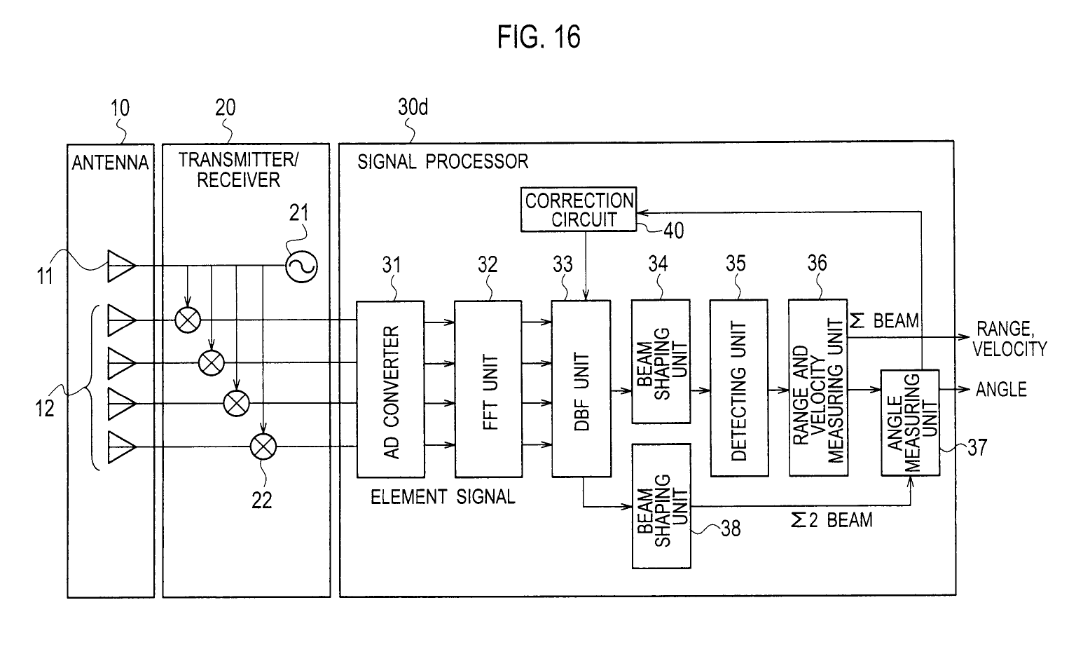

FIG. 16 is a system diagram showing a configuration of a radar apparatus according to Embodiment 4 of the present invention. This radar apparatus is configured by adding a correction circuit 40 to the signal processor 30b of the radar apparatus according to Embodiment 2. The correction circuit 40 calculates a correction coefficient based on a signal outputted from the angle measuring unit 37, and sends the coefficient to the DBF unit 33.

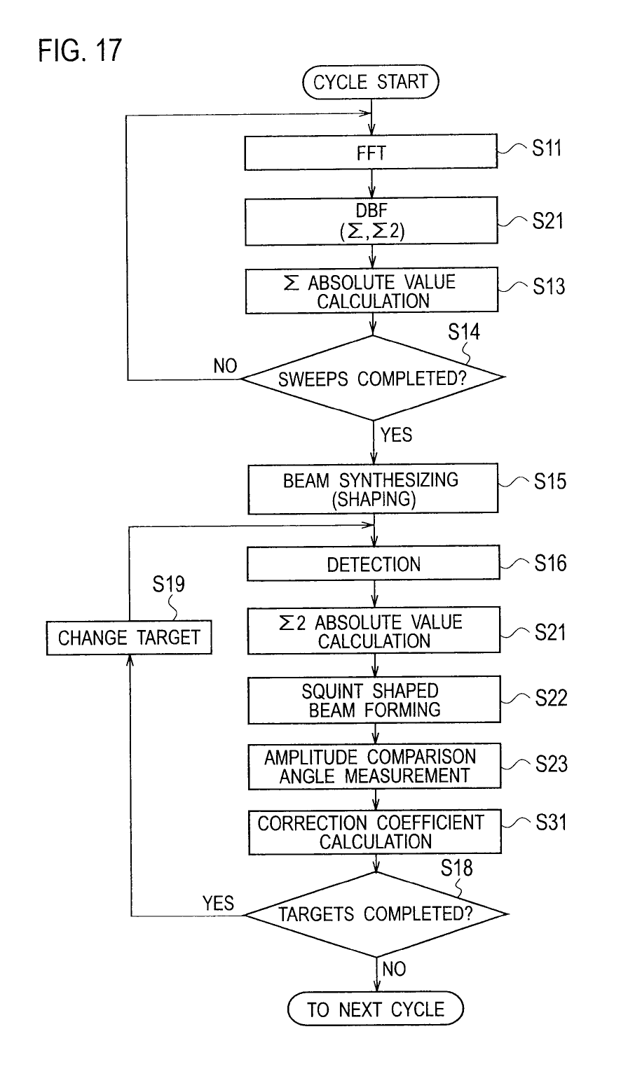

FIG. 17 is a flowchart showing operations of the radar apparatus according to Embodiment 4 of the present invention. This flowchart is configured by inserting correction coefficient calculation processing (step S31) between step S24 and step S18 in the flowchart showing the operations of the radar apparatus according to Embodiment 2 shown in FIG. 9. In the following, the step in which identical or corresponding processing to the one in the radar apparatus according to Embodiment 2 is performed is labeled with the same reference numeral as used in the flowchart of FIG. 9, and its description is omitted.

In the correction coefficient calculation processing in step S31, the correction circuit 40 calculates a correction coefficient based on a signal sent from the angle measuring unit 37, and sends the correction coefficient to the DBF unit 33. The DBF unit 33 forms a Σ beam by using an element signal on the frequency axis sent from the FFT unit 32, and the correction coefficient sent from the correction circuit 40.

The step of correcting the amplitude and phase of an element signal is as shown below. The step is performed by passive reception using transmission/reception signals of oncoming vehicles.

(1) An oncoming vehicle is detected and the angle to the vehicle is measured and the measured angle value θk is obtained by using the target's signal with a high S/N exceeding a predetermined threshold (FIG. 22).

(2) The slope of the wave front is calculated by the measured angle value θk (FIG. 23).

[Equation 15]

θec(n)=k·d(n)·sin(θk) (16)

where

d(n): element position,

n=1 to N (N the number of elements), and

k: wave number 2π/λ(λ: wave length).

(3) The phase of an antenna element, Φe(n) is extracted, Φe(n)=ang [e(n)].

(4) The correction phase Δφ(n) is calculated. Φe(n)=ang [e(n)].

(5) The correction phase ΔA(n) is calculated.

$$\begin{matrix}[ Equation 16 ] & \\ Δ A ( n ) = \frac{1}{abs [ e ( n ) ]} & ( 17 )\end{matrix}$$

where

abs: absolute value.

(6) Complex correction coefficient C(n) is common to the case of up-chirp signal and the case of down-chirp signal, and is given by the following equation.

[Equation 17]

C(n)=A·exp(j·Δφ(n)) (18)

When a beam is formed using this correction coefficient, the element signal is multiplied by the correction coefficient C(n), and then the beam is calculated.

Also, in Embodiment 1, the configuration can be such that the correction coefficient is calculated after determining the target is in the vicinity of the front from that the measured angle value is near 0. According to this configuration, a large correction error can be avoided when the target is deviated from the front direction.

As described above, according to the radar apparatus according to Embodiment 4 of the present invention, an angle is measured by using a radar transmission/reception wave or a reception wave from an interference wave so that the amplitudes and phase planes of the antenna elements can be aligned according to the measured angle value. Thereby, the formed beam distorted by an error can be formed into a sharp beam with less influence of error, and further beam shaping reduces sidelobes and erroneous detection so that accuracy in the angle measurement can be improved.

### Embodiment 5

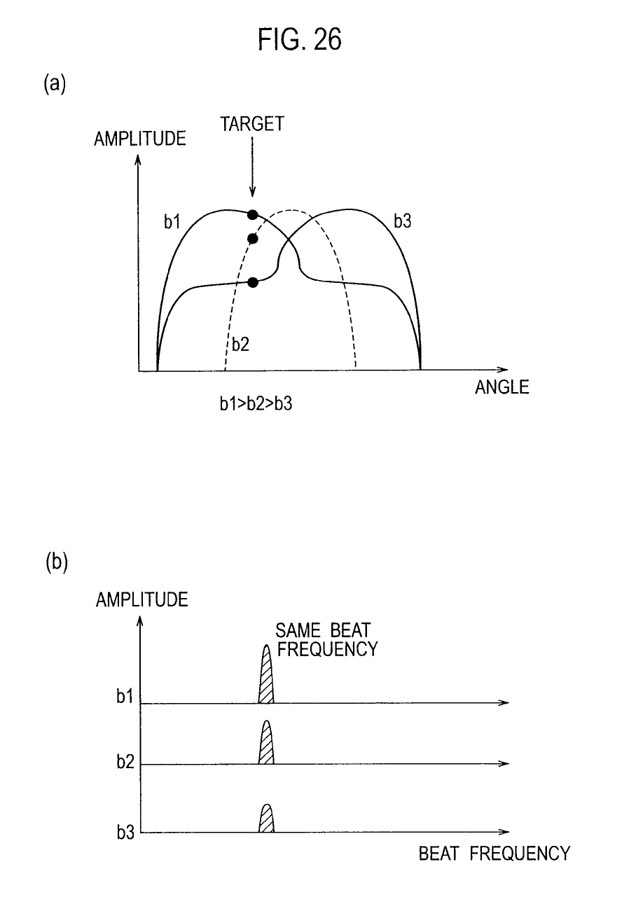

A radar apparatus transmits an FMCW (Frequency Modulated Continuous Wave) modulated frequency sweep signal, uses the same transmission signal as a local signal and demodulates the transmission signal to obtain a beat frequency. When M beams are formed by an antenna with N elements, a target may be observed at the same beat frequency by the M beams. The case of three beams b1 to b3 is shown in FIG. 26. It is satisfactory if the target can be separated with the M beams. However, if the sidelobes of a beam is high, even for a single target, the target may be observed with a threshold exceeded in the multiple beams, and thus an erroneous angle measurement may be performed.

To address this, a radar apparatus according to Embodiment 5 of the present invention selects only beam b1 which has the maximum beam output level within the same frequency bank. The configuration of the radar apparatus according to Embodiment 5 is the same as that of the radar apparatus according to Embodiment 1 shown in FIG. 6.

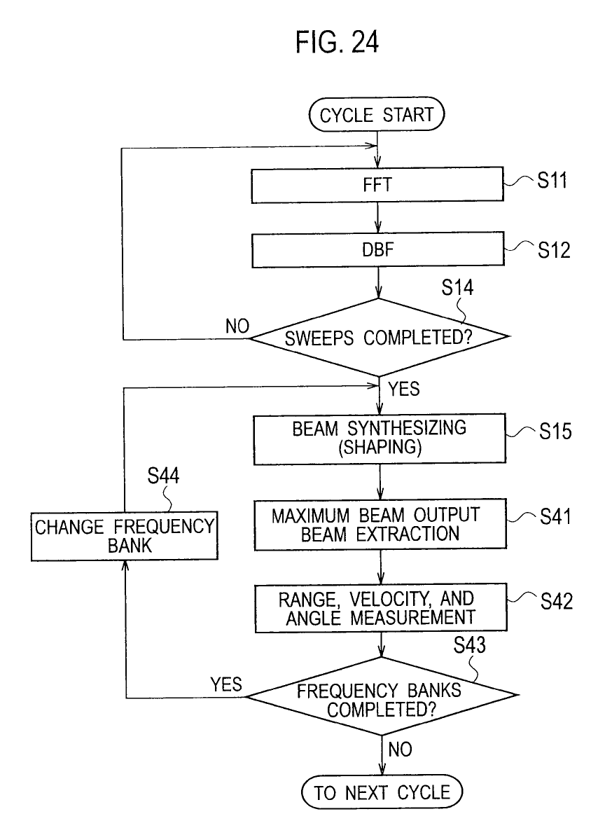

FIG. 24 is a flowchart showing operations of the radar apparatus according to Embodiment 5. The step in which identical or corresponding processing to the one in the radar apparatus according to Embodiment 1 is performed is labeled with the same reference numeral as used in the flowchart of FIG. 7, and its description is omitted. When a cycle is started, the Fast Fourier Transform (FFT) is first performed (step S11). Subsequently, DBF processing is performed (step S21). Subsequently, it is checked whether the sweeps are completed or not (step S14). If the sweeps are not completed in step S14, the process returns to step S11, then the above-described processing is repeated for the next sweep signal.

On the other hand, if the sweeps are completed in step S14, beam synthesizing is performed (step S15). Subsequently, the beam with the maximum beam output is extracted (step S41). That is, the detection unit 35 extracts the beam with the maximum beam output from synthesized Σ beam sent from the beam shaping unit 34, and sends the beam to the range and velocity measuring unit 36.

Subsequently, a range, velocity, and angle are measured (step S42). That is, the range and velocity measuring unit 36 performs range and velocity measurement based on the beam sent from the detection unit 35, and outputs the range and velocity obtained by the range and velocity measurement to the outside. Also, the angle measuring unit 37 performs monopulse angle measurement based on the Σ beam sent from the DBF unit 33 via the beam shaping unit 34, the detection unit 35, and the range and velocity measuring unit 36 and the Δ beam sent from the DBF unit 33, then outputs the angle obtained by this angle measurement to the outside.

Subsequently, it is checked whether the frequency banks are completed or not (step S43). That is, it is checked whether processing to all frequency banks is completed or not. If the frequency banks are not completed in step S43, the frequency bank is changed to the next frequency bank (step S44). Subsequently, the process returns to step S15, and the above-described processing is repeated. On the other hand, if the frequency banks are completed in step S43, the process is terminated.

As described above, when only the beam with the maximum beam output is extracted, the difference between the maximum beam output and the second maximum beam output is reduced. For example, a case may be considered in which one target is observed in two adjacent beams, and false angle measurement is outputted. To address this, the maximum beam extraction step may be modified in such a manner that the beam output levels are rearranged in descending order within the same frequency bank, and the first beam is selected if the difference between the first and the second beam is a predetermined value or more, and then angle measurement is performed.

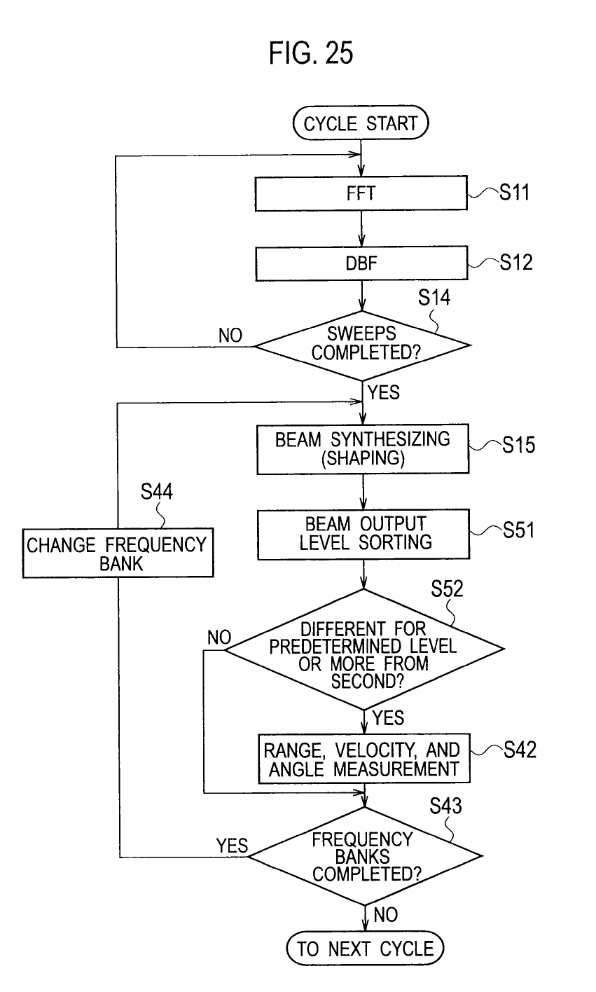

FIG. 25 is a flowchart showing the processing of the radar apparatus according to this modification. The step in which identical or corresponding processing to the one in the radar apparatus according to Embodiment 5 is performed is labeled with the same reference numeral as used in the flowchart of FIG. 24, and its description is omitted.

If the sweeps are completed in step S14, beam synthesizing is performed (step S15). Subsequently, the beam output levels are sorted (step S51). That is, the detection unit 35 sorts the synthesized Σ beams sent from the beam shaping unit 34, and sends the Σ beams to the range and velocity measuring unit 36.

Subsequently, it is checked whether or not the difference between the first beam output level (maximum output level) and the second beam is a predetermined level or more (step S52). That is, the detection unit 35 refers to the beams sorted in step S51 to check whether or not the first beam is followed by the second beam different from the first beam for a predetermined value or more. If the difference between the first and the second output level is a predetermined value or more in step S52, then, range, velocity, and angle measurement are performed (step S42). On the other hand, if the largest beam is not greater than the second largest beam by a margin of a predetermined level or more in step S52, the processing in step S42 is skipped.

Subsequently, it is checked whether the frequency banks are completed or not (step S43). If the frequency banks are not completed in step S43, the frequency bank is changed to the next frequency bank (step S44), then the processing returns to step S15, and the above-described processing is repeated. On the other hand, if the frequency banks are completed in step S43, the process is terminated.

As described above, according to the radar apparatus according to Embodiment 5 of the present invention, if there is a signal with the same frequency bank in M beams, the beam with the maximum output level (the first), or the beam with the maximum output level different from the second maximum beam output for a predetermined level or more is selected. Thereby, fluctuation of the observed value due to the measured range, velocity, and angle values of the second largest beam and the rest can be suppressed.

### Embodiment 6

In the radar apparatus according to Embodiment 5 described above, it is satisfactory if only one target is present in the same frequency bank. However, if two or more targets are present, the second target and the rest are ignored. To address this, in a radar apparatus according to Embodiment 6 of the present invention, if two beams apart from each other with one or more beams exceed a threshold, it is assumed that the target has been detected and the angle measurement is performed.

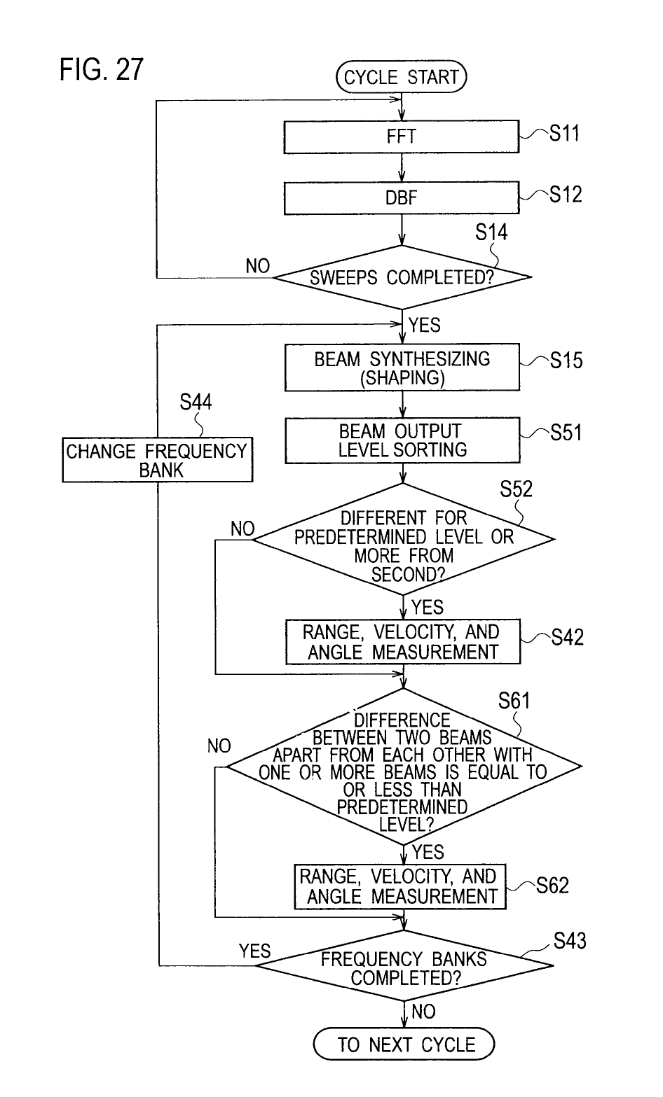

The configuration of the radar apparatus according to Embodiment 6 is the same as that of the radar apparatus according to Embodiment 1 shown in FIG. 6. FIG. 27 is a flowchart showing the operation of the radar apparatus according to Embodiment 6. The step in which identical or corresponding processing to the one in the radar apparatus according to the modification of Embodiment 5 is performed is labeled with the same reference numeral as used in the flowchart of FIG. 25, and its description is omitted.

If the sweeps are completed in step S14, beam synthesizing is performed (step S15). Subsequently, the beam output levels are sorted (step S51). Subsequently, it is checked whether or not the difference between the first and second beams is a predetermined level or more (step S52). If the difference between the first and second beams is a predetermined level or more in step S52, range, velocity, and angle measurement are performed (step S42). On the other hand, if the difference between the first and second beams is less than a predetermined level in step S52, the processing in step S42 is skipped.

Subsequently, it is checked whether two beams apart from each other with one or more beams have a predetermined level of difference or less (step S61). If two beams apart from each other with one or more beams have a predetermined level of difference or less in step S61, then range, velocity, and angle measurement are performed (step S62). The processing in step S62 is the same as that in step S42. On the other hand, if two beams apart from each other with one or more beams have more than a predetermined level of difference in step S61, the processing in step S62 is skipped.

Subsequently, it is checked whether the frequency banks are completed or not (step S43). If it is determined that the frequency banks are not completed in step S43, the frequency bank is changed to the next frequency bank (step S44), then the process returns to step S15, and the above-described processing is repeated. On the other hand, if the frequency banks are completed in step S43, the process is terminated.

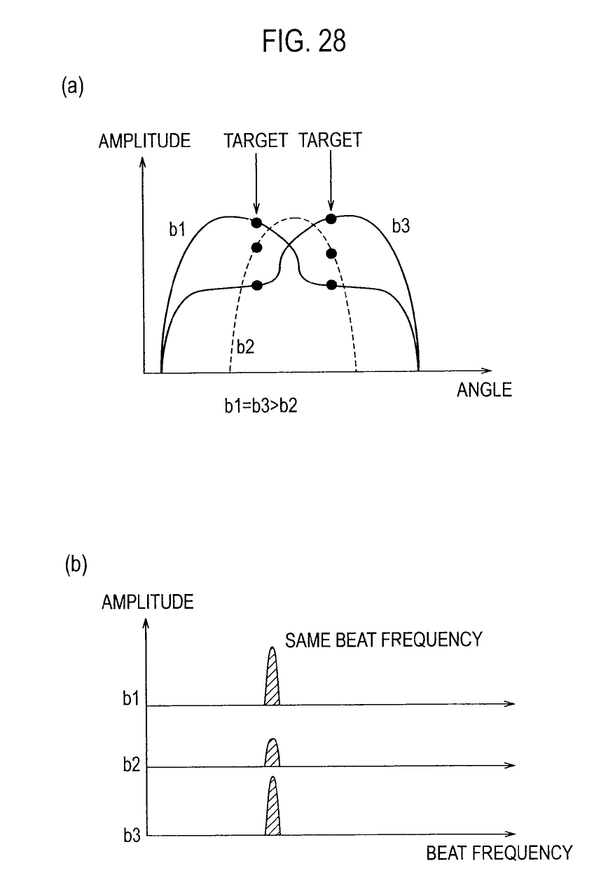

FIG. 28 is a graph for explaining operations of the radar apparatus according to Embodiment 6 when two targets are present. In a phased array that forms M beams by an antenna with N elements, an FMCW modulated frequency sweep signal is transmitted, and on the beat frequency axis where the transmission signal is demodulated, if the beam output levels of bm1 and bm2 apart from each other with one or more beams (b1 and b3 in the example shown in FIG. 28) among the outputs of M beams of the same frequency bank fp are a predetermined threshold or less, range, velocity, and angle measurement of the beams of bm1 and bm2 are performed with respect to the frequency bank fp, and the result is outputted.

As described above, according to the radar apparatus according to Embodiment 6 of the present invention, if there is a signal of the same frequency bank in M beams, by using measured range, velocity, angle values of the beam outputs apart from each other with one or more beams as the observed values, multiple targets of the same frequency bank can be detected.

### Embodiment 7

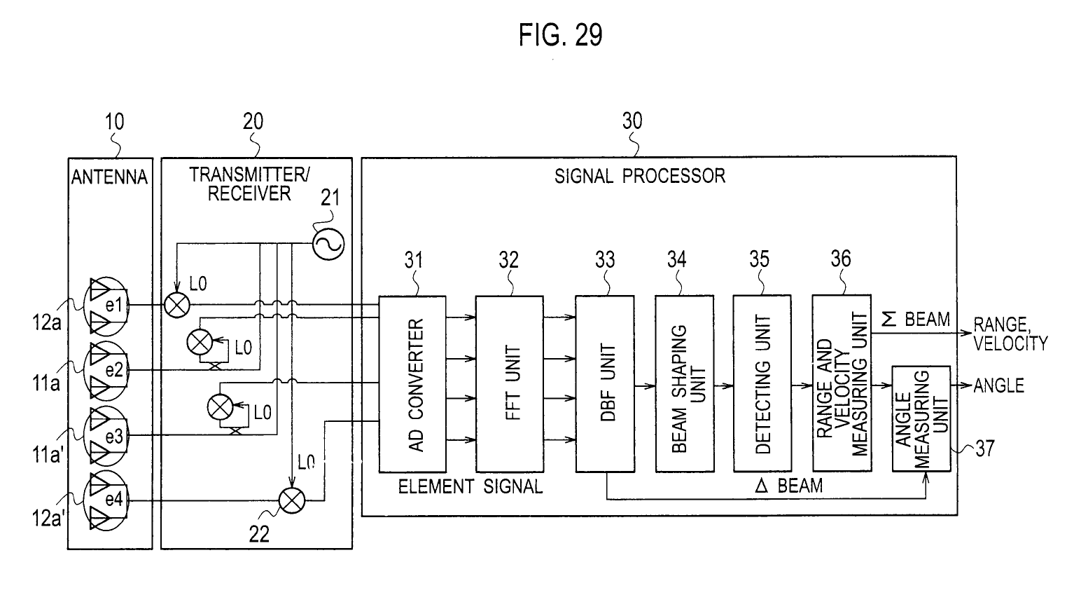

FIG. 29 is a system diagram showing a configuration of a radar apparatus according to Embodiment 7 of the present invention. In the radar apparatus, the internal configuration of an antenna 10 and a transmitter/receiver 20 that have antenna receiving arrays 12a, 12a′, and antenna transmitting/receiving arrays 11a, 12a′, each being divided in two is different from that of the radar apparatus according to Embodiment 1. In the following, portions different from those in the radar apparatus according to Embodiment 1 are mainly described.

FIG. 29 is a system diagram showing a configuration when an element for use in both transmission and reception is present, for example, when M beams are formed in Embodiment 1. If a wide angle region is observed and a phase shifter for transmission cannot be used, the entire angle region needs to be covered in transmission, and thus the antenna aperture length for transmission cannot be made large. Thus, in order to form a reception beam with a narrow beam width to secure the angle accuracy, the number of channels of the transmitter/receiver needs to be increased, thus the cost is increased.

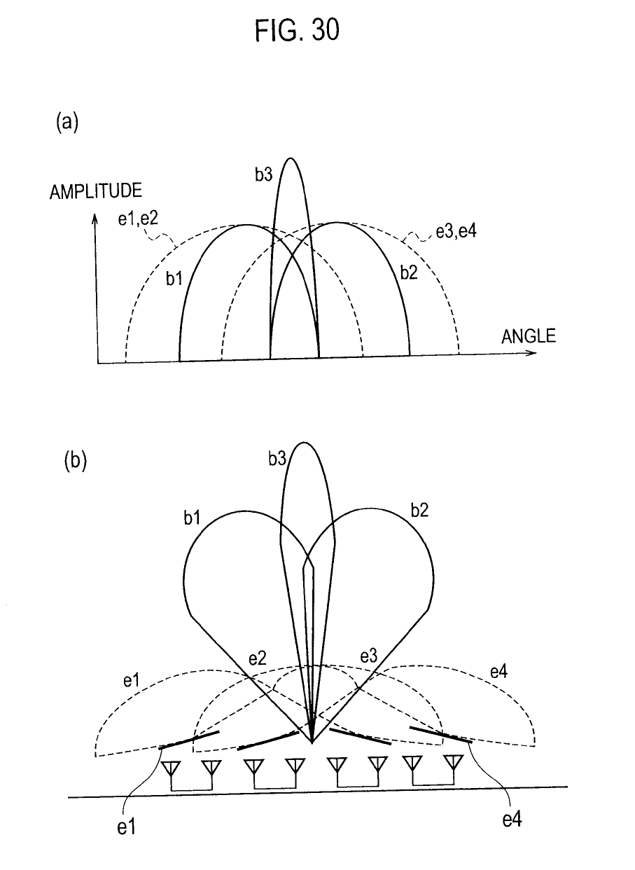

To address this, the radar apparatus according to Embodiment 7 of the present invention is used with the observation angle region being divided. For the sake of simplicity, 4 sub arrays (two antenna receiving arrays 12a, 12a′ as an element for reception only, and two antenna transmitting/receiving arrays 11a, 11a′ as an element for use in both transmission and reception) are illustrated as shown in FIG. 30.

Here, the antenna receiving array 12a generates a sub array beam pattern e1. The antenna transmitting/receiving array 11a generates a sub array beam pattern e2. The antenna transmitting/receiving array 11a′ generates a sub array beam pattern e3. The antenna receiving array 12a′ generates a sub array beam pattern e4.

For the sub array beam patterns e1 to e4, a phase of RF (radio frequency) power supply circuit of each sub array is set so that each pair of e1 and e2, and e3 and e4 has the same aimed direction, and transmission beams are formed so as to cover respective divided observation angle region. The phase of the power supply circuit can be in phase with the aimed beam direction by taking the position of each sub array into consideration.

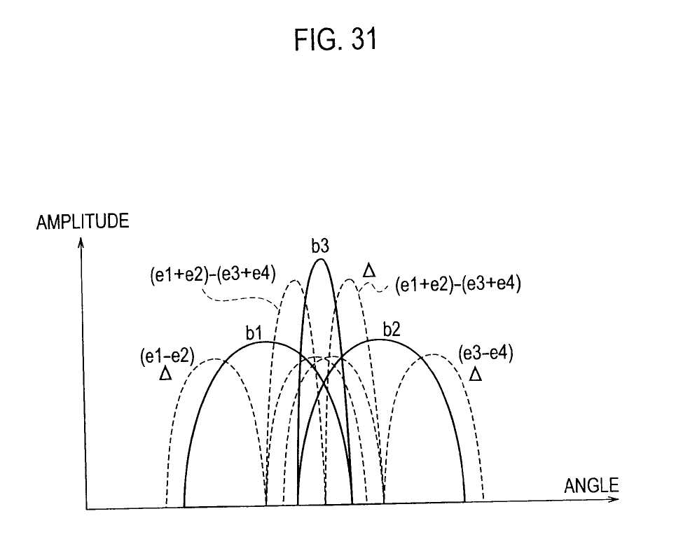

In reception, complex weight of DBF is controlled so as to be in phase with the aimed beam direction, and the b1 beam is formed by e1 and e2, and the b2 beam is formed by e3 and e4. Also, b3 with a narrow beam width is formed by e1 to e4. The beams of b1, b2, and b3 may form phase monopulse beams of Σ and Δ for angle measurement as shown in FIG. 31.

Especially, b3 with a narrow beam width among these b1, b2, and b3 has a shifted phase plane of RF power supply circuit, and thus sidelobes tend to be increased. To address this, the sidelobes are reduced by the method described in Embodiment 1 using b1 and b2.

As described above, according to the radar apparatus according to Embodiment 7 of the present invention, in an array antenna including elements (sub arrays) for use in both transmission and reception and for reception only, a signal is transmitted to a wide angle region by a small number of elements (sub arrays), and a wide angle region is observed with a beam having a wide beam width by some of the elements (sub arrays). Also, when a narrow angle region is observed with sufficient accuracy by a beam having a narrow beam width using the entire elements (sub arrays), sidelobes can be reduced by beam shaping and the influence of unnecessary waves is lowered so that erroneous detection can be reduced.

### INDUSTRIAL APPLICABILITY

The present invention can be used for a radar apparatus that measures a direction of a vehicle and the like with a high accuracy.

### REFERENCE SIGNS LIST

10 antenna
11 antenna transmitting element
11a antenna transmitting/receiving array
12 antenna receiving element
12a antenna receiving array
20 transmitter/receiver
21 transmitter
22 mixer
30 signal processor
31 AD converter
32 FFT unit
33 DBF unit
34,38 beam shaping unit
35 detection unit
36 range and velocity measuring unit
37 angle measuring unit
39,40 correction circuit

1. A radar apparatus comprising:
an antenna including element for use in both transmission and reception that is divided into a first transmission/reception element and a second transmission/reception element, and element for reception only that is divided into a first only-reception element and a second only-reception element;
a beam shaping unit that divides an angle region to be observed into a plurality of regions, and forms transmission beams by using the respective elements of the antenna so that the divided angle regions are covered by the transmission beams, and in reception, sets aimed beam direction of each element of the antenna to be the same as that of the first transmission/reception element, and that of the second transmission/reception element, forms phase monopulse beam of Σ and Δ by using the first transmission/reception element and the first only-reception element, and the second transmission/reception element and the second only-reception element to cover each of the plurality of angle regions, and forms a beam with a narrow beam width by the first transmission/reception element, the second transmission/reception element, the first only-reception element, and the second only-reception element; and
an angle measuring unit that performs monopulse angle measurement based on the beam formed in the beam shaping unit.

2. A radar apparatus comprising:
an antenna that has a plurality of elements;
a beam shaping unit that forms a beam shaped by multiplying absolute values of a plurality of received beams formed based on a plurality of signals from the antenna by a predetermined coefficient, and by adding resultant values of the multiplication; and
an angle measuring unit that performs monopulse angle measurement for a beam exceeding a predetermined threshold out of beams formed in the beam shaping unit.

3. A radar apparatus comprising:
an antenna that has a plurality of elements;
a first beam shaping unit that forms a first beam shaped by multiplying absolute values of a plurality of received beams formed based on a plurality of signals from the antenna by a predetermined coefficient, and by adding resultant values of the multiplication;
a second beam shaping unit that forms a second beam shaped by multiplying absolute values of a plurality of received beams formed based on a plurality of signals from the antenna by a predetermined coefficient, and by adding resultant values of the multiplication; and
an angle measuring unit that performs monopulse angle measurement for a beam exceeding a predetermined threshold out of the first beams formed in the first beam shaping unit by using the first beam and the second beam formed in the second beam shaping unit.

4. A radar apparatus comprising:
an antenna that has a plurality of elements;
an FFT unit that samples a signal from an antenna that transmits an FMCW modulated frequency sweep signal or receives an interference wave from an oncoming vehicle, and performs Fast Fourier Transform on the signal;
a correction circuit that performs any one of a correction in which, when an output of the FFT unit exceeds a predetermined threshold, least square fitting is performed for phases for respective elements with a first degree equation and phase planes are aligned so as to match to a slope of a straight line; and a correction in which, when an output of the FFT unit exceeds the predetermined threshold, monopulse angle measurement is performed and phase planes are aligned so as to match to phase slope according to a measured angle value obtained by the monopulse angle measurement; and
an angle measuring unit that performs monopulse angle measurement after correction by the correction circuit.

5. A radar apparatus comprising:
an antenna that has a plurality of elements;
a detection unit that transmits an FMCW modulated frequency sweep signal, and detects a beam with the maximum value or a beam with the maximum value different from a second largest output level for a predetermined level or more, or two beams apart from each other with one or more beams therebetween that have a predetermined level difference or less, out of outputs of a plurality of beams of the same frequency bank on a beat frequency axis where the transmitted signal is demodulated;
a range and velocity measuring unit that performs range and velocity measurement for a plurality of frequency banks by using a beam detected in the detection unit; and
an angle measuring unit that performs angle measurement for a plurality of frequency banks by using a beam detected in the detection unit.
